(19) United States
(12) Patent Application Publication
(10) Pub. No.: US 2012/0123905 A1
(43) Pub. Date: May 17, 2012

(54) PURCHASING-ASSISTANCE DEVICE AND SYSTEM AND METHOD USING THE SAME

(76) Inventors: Szu-Han TZAO, Guishan Township (TW); Sin-Shi Lin, Hsinchu City (TW); Tzu-Ya Yang, Taipei City (TW)

(21) Appl. No.: 13/028,583

(22) Filed: Feb. 16, 2011

(30) Foreign Application Priority Data
Nov. 11, 2010 (TW) 99138886

(51) Int. Cl. G06Q 30/00; G06K 5/00; G06F 17/00

(52) U.S. Cl. 705/26.81; 235/383; 235/380

(57) ABSTRACT

A assistance device and a system for purchasing and a method using the same. The method includes the following steps. A portable body is provided for a shopper to carry with. A code of a merchandise is read by the portable body to confirm the type and price of the merchandise. The information of the merchandise purchased by the shopper is recorded in the portable body and listed on a purchase list. The purchase list is transmitted to a trade center, which settles the accounts according to the purchase list and withdraws the portable body after the accounts are settled.

This application claims the benefit of Taiwan application Ser. No. 99138886, filed Nov. 11, 2010, the subject matter of which is incorporated herein by reference.

### BACKGROUND

1. Technical Field

The disclosure relates in general to a purchasing assistance device, system and method, and more particularly to a purchasing-assistance device and a system and a method using the same.

2. Description of the Related Art

Shopping at shopping centers or supermarkets on off days has become a part of lifestyle to people who live in a city. While shopping centers or hypermarkets provide all sorts of merchandise to meet the shoppers' needs, shopping at shopping centers or supermarkets is itself an entertainment or pleasure to many people. It is very common that shoppers go shopping and at the same time go for other leisure activities.

In shopping centers, shoppers normally walk with a trolley which often makes the shoppers trapped in the crowd due to its huge size. Also, when a shopper lines up to settle accounts, the purchased merchandise must be taken out one by one for the checkout staff to scan the bar code of the merchandise and then the scanned merchandise is placed back to the trolley or the hand bag. Thus, the shoppers may spend a considerable account of time doing account settlement. For the shoppers' convenience of parking, the shopping centers normally have a huge car park. However, the parking space is still not enough particular during the weekend or holidays. Moreover, for those pink-collar workers, seniors or public transport lovers who are lack of transport, it is by no means an easy job to bring the purchased merchandise home, and extra time and efforts must be paid. Also, getting on/off transport with the purchased merchandise at hand is really a nuisance that deprives the shopper of shopping pleasure. Under such circumstances, the shopper will not have the mood to do other leisure activities.

### SUMMARY

The disclosure is directed to a purchasing-assistance device and a system for purchasing and a method using the same. The purchasing-assistance device assists the shopper in inquiring the type and price of merchandise, records the information of the purchased merchandise and lists the information on a purchase list for setting accounts with.

The disclosure is directed to a purchasing-assistance device and a system for purchasing and a method using the same. The system assists the shopper in settling accounts more quickly and conveniently, and further provides delivery service for delivering the purchased merchandise to designated location.

According to a first aspect of the present disclosure, a purchasing-assistance device is provided. The device includes a portable body carried by a shopper for recording the information of the merchandise purchased by a shopper and listing the information on a purchase list. The portable body includes a merchandise identification unit, a data input unit, a merchandise information display unit and a data transmission unit. The merchandise identification unit is used for reading a code of a merchandise to confirm the type and price of the merchandise. The input unit is used for confirming the quantity and amount of the purchased merchandise. The merchandise information display unit is used for displaying the type, quantity and amount of each merchandise in the purchase list. The data transmission unit is used for transmitting the purchase list to a trade center for shoppers to settle accounts with.

According to a second aspect of the present disclosure, a purchasing-assistance system is provided. The system includes at least a portable body, a merchandise display center, a data exchange center, a trade center and a delivery management center. The portable body is carried by at least a shopper for recording the information of the merchandise purchased by the shopper and listing the information on a purchase list for the shopper to settle accounts with. The merchandise display center provides a code of a merchandise to be read for each shopper to confirm the type and price of the merchandise. The data exchange center transmits data with each portable body for recording the type, quantity and amount of each merchandise in the purchase list. The trade center is connected to the data exchange center for settling accounts with the shopper and withdrawing the portable body after the accounts are settled. The delivery management center is used for delivering the merchandise to the location registered or designated by the shopper according to the content of the shopper's purchase list. The delivery management center also determines whether the total quantity of the merchandise purchased by the shopper or the total amount of consumption of the shopper reaches a delivery threshold. If yes, the merchandise is delivered to the designated location.

According to a third aspect of the present disclosure, a purchasing-assistance method is provided. The method includes the following steps: A portable body is provided for a shopper to carry with. A code of a merchandise is read by the portable body to confirm the type and price of the merchandise. The information of the merchandise purchased by the shopper is recorded in the portable body, and listed on a purchase list. The purchase list is transmitted to a trade center, which settles the accounts according to the purchase list and withdraws the portable body after the accounts are settled. The merchandise is delivered to the location registered or designated by the shopper according to the content of the shopper's purchase list, or whether the total quantity of the merchandise purchased by the shopper or the total amount of consumption of the shopper reaches a delivery threshold is determined. If yes, the merchandise is delivered to the designated location.

The above and other aspects of the disclosure will become better understood with regard to the following detailed description of the exemplary but non-limiting embodiment(s). The following description is made with reference to the accompanying drawings.

### BRIEF DESCRIPTION OF THE DRAWINGS

FIGS. 1A and 1B respectively show a front view and a rear view of a purchasing-assistance device according to an embodiment.

FIG. 2 shows a structural diagram of a purchasing-assistance system according to an embodiment.

FIG. 3 shows a flowchart of a purchasing-assistance method according to an embodiment.

### DETAILED DESCRIPTION

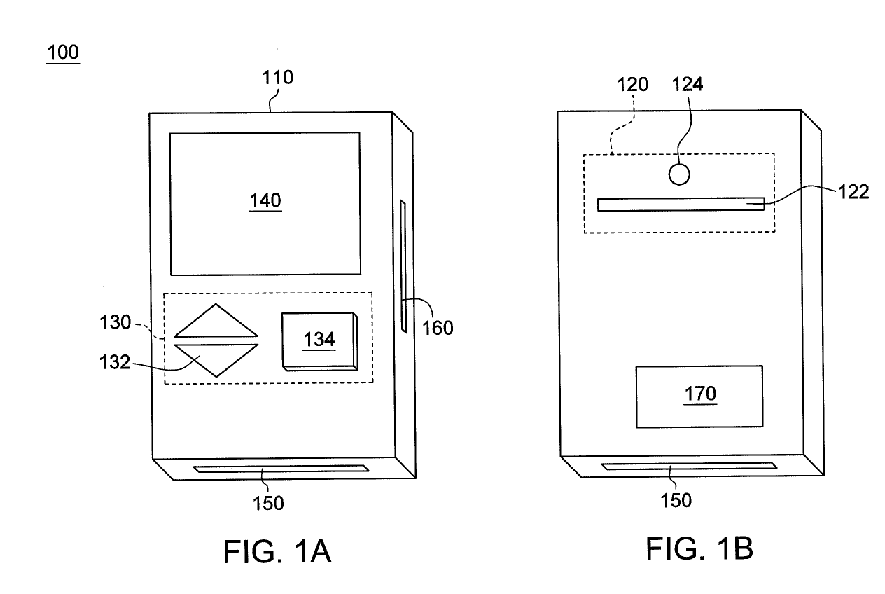

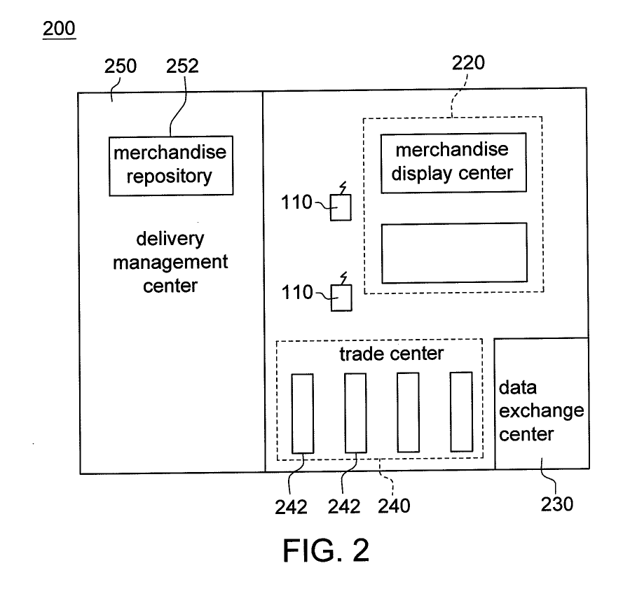

The assistance device and the system for purchasing and the method disclosed in the present embodiment of the disclosure are respectively illustrated in FIGS. 1A, 1B, 2 and 3. Referring to FIGS. 1A and 1B, a front view and a rear view of a purchasing-assistance device according to an embodiment are respectively shown. The purchasing-assistance device 100 includes a portable body 110 carried by a shopper for recording the information of the merchandise purchased by the shopper and listing the information on a purchase list. The portable body 110 includes a merchandise identification unit 120, an input unit 130, a merchandise information display unit 140 and a data transmission unit 150. The merchandise identification unit 120 is used for reading a merchandise code to confirm the type and price of the merchandise. The input unit 130 is used for confirming the quantity and amount of the purchased merchandise. The merchandise information display unit 140 is used for displaying the type, quantity and amount of each merchandise in the purchase list. The data transmission unit 150 is used for transmitting the purchase list to a trade center 240 (referring to FIG. 2) for the shopper to settle accounts with.

Referring to FIG. 2, a structural diagram of a purchasing-assistance system according to an embodiment is shown. The purchasing-assistance system 200 includes at least a portable body 110, a merchandise display center 220, a data exchange center 230, a trade center 240 and a delivery management center 250. When more than one portable body 110 is used, each shopper can carry a portable body 110 for recording the information of the purchased merchandise and listing the information on a purchase list for the shopper to settle accounts with. The merchandise display center 220 provides a code of a merchandise to be read for the shopper to confirm the type and price of the merchandise. The data exchange center 230 transmits data with each portable body 11 for recording the type, quantity and amount of each merchandise in the purchase list. The trade center 240 is connected to the data exchange center 230 for settling accounts with each shopper and withdrawing the portable body 110 after the accounts are settled. The delivery management center 250 is used for delivering the merchandise to the location registered or designated by the shopper according to the content of the shopper's purchase list, or determining whether the total quantity of the merchandise purchased by the shopper or the total amount of consumption of the shopper reaches a delivery threshold. If yes, the merchandise is delivered to the designated location.

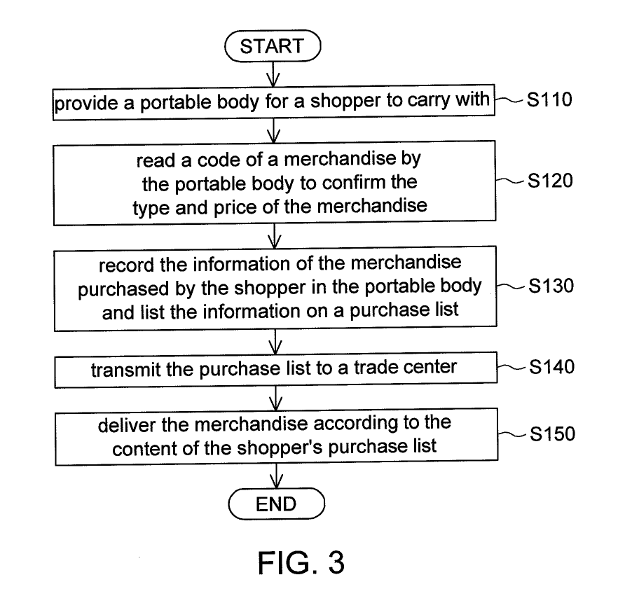

Referring to FIG. 3, a flowchart of a purchasing assistance method according to an embodiment is shown. The purchasing-assistance method includes steps S110˜S150. The purchasing assistance method of FIG. 3 is elaborated below with the purchasing-assistance device of FIGS. 1A and 1B and the purchasing-assistance system of FIG. 2.

In the step S110 of FIG. 3, a portable body 110 is provided for a shopper to carry with. Referring to FIG. 1A and 1B. In an embodiment, the portable body 110, realized by such as a portable electronic device, has a processing unit (not illustrated) and a memory unit (not illustrated). The processing unit is electrically connected to the merchandise identification unit 120, and is capable of processing the merchandise code read by the merchandise identification unit 120, and recording and calculating the quantity and amount of purchase. The processing unit can temporarily store the result of calculation in the memory unit for the use of account settlement.

In the step S120, a code of a merchandise is read by the portable body 110 to confirm the type and price of the merchandise. Examples of the merchandise code include optical readable image, two dimensional bar code or wireless radio frequency identification code. The merchandise code is used for recording the information of the merchandise such as the type, price, serial number, and place of production. Thus, each merchandise has a merchandise code by which the shopper inquires the type and price of the merchandise.

In an embodiment, when a merchandise is delivered, a merchandise code is already printed on a label of the merchandise and displayed in a merchandise display center 220 (referring to FIG. 2), the user can obtain the type and price of the merchandise by reading a bar code with the optical pick-up head 122 of the merchandise identification unit 120 or capturing an image with the merchandise identification unit 120 having an image identifier 124. In another embodiment, the merchandise code is such as disposed on an inquiry counter of the merchandise display center 220, and the user can obtain the type and price of the merchandise by reading the bar code with the optical pick-up head 122 of the merchandise identification unit 120 or capturing the image with the merchandise identification unit 120 having an image identifier 124.

In the step S130, the information of the merchandise purchased by the shopper is recorded in the portable body 110, and listed on a purchase list. Referring to FIG. 1. The input unit 130 has multiple function keys 132 and 134 by which the shopper inputs an instruction, moves the curser, selects a menu and/or confirms the execution. Examples of the function keys 132 and 134 include direction keys, a delete key, a enter key or other hot keys. Besides, the merchandise information display unit 140, realized by a display interface such as LCD panel and touch panel, can correspondingly display various sorts of merchandise information such as the type, the quantity and the amount according to the instruction inputted by the shopper. In addition, the merchandise information display unit 140 can also display the discount price, special price or member price of a particular merchandise to keep the shopper informed of the latest information of special offers.

In an embodiment, the shopper does not need to put the purchased merchandise at the trolley. Instead, the shopper only needs to read the type and price of the merchandise and input the quantity of purchase, and then the portable body 110 will automatically calculate the amount and discount of the purchase. When the shopper finishes shopping, the information of all purchased merchandise will be displayed on the display panel for the shopper to confirm. If the confirmation is affirmative, the information on a purchase list is listed for the use of account settlement. At any time, the shopper can update the purchase information stored in the portable body 110, wherein the purchase information is such as the quantity of purchase, the newly added purchase, and the newly deleted purchase.

In an embodiment, if the shopper has a membership and brings a member card with him/her, the portable body 110 may further include a member card reading module 160 which reads the shopper's profile information to confirm the shopper's identity. If the shopper forgets to bring his/her member card, the shopper can show his/her identification or report his/her membership number, then the checkout staff will settle the accounts with member discount or special offer for members.

In the step S140, the purchase list is transmitted to a trade center 240. Referring to FIGS. 1A, 1B and 2. The data transmission unit 150, realized by such as a wireless transmission module, is used for transmitting the purchase list to a data exchange center 230 or receiving the data outputted from the data exchange center 230. The data exchange center 230, realized by such as a remote server, transmits data with the portable body 110 through a communication protocol to record the type, quantity and amount of each merchandise in the purchase list. In FIG. 2, the trade center 240 can be connected to the data exchange center 230 located at a remote end for the checkout staff to confirm the quantity and amount of the merchandise purchased by the shopper. In an embodiment, since the shopper does not need to put the purchased merchandise at the trolley, the checkout staff does not need to take out the purchased merchandise one by one in order to read the bar code of the purchased merchandise and does not need to input the quantity of purchase either. Thus, the efficiency of account settlement is increased.

In an embodiment, the system administrator can update the price and quantity of the merchandise through the data exchange center 230 in a real-time manner, and can provide limited-stock on site promotion for selected merchandise at selected time periods. In the present embodiment, since the shopper does not need to walk with a huge trolley, the shopper will not be trapped in the crowd of shoppers. Besides, the information of the shopper's purchase will be connected and transmitted to the data exchange center 230 and the shopper will be informed of the on-site promotion or limited-stock promotion through the portable body 110 in a real-time manner.

In an embodiment, the trade center 240 has such as multiple checkout gates 242 capable of settling accounts for several shoppers' at the same time. After the accounts are settled, each shopper returns the portable body 110 to the trade center 240. Referring to FIG. 1B. To avoid the shopper passing through the checkout gate 242 without returning the portable body 110, the portable body 110 can further be equipped with a sensing detecting module 170. The sensing detecting module 170 includes a emitter (not illustrated) or a sensor (not illustrated) for emitting a signal or sensing a signal to determine whether the portable body 110 is positioned within a use range such as the merchandise display center 220. In an embodiment, when the shopper settles accounts, the checkout staff must first of all perform degaussing or remove the detection signal before the shopper can pass through the checkout gate 242. If the signal emitted by the emitter or the signal sensed by the sensor is detected by the processor of the checkout gate 242, the alarm system will be triggered and make an alarming sound or notify the checkout staff so that the portable body 110 will not be removed outside the use range.

In an embodiment, the portable body 110 is further equipped with a bracelet for the shopper to wear on the hand or equipped with a necklace for the shopper to wear on the neck. Thus, the style of the portable body 110 is not limited to hand-held style, and can be adjusted to fit actual needs.

In the step S150, the merchandise is delivered to the location registered or designated by the shopper according to the content of the shopper's purchase list. In another embodiment, a delivery threshold is set, and whether the total quantity of the merchandise purchased by the shopper or the total amount of consumption of the shopper reaches the delivery threshold is determined. If the determination is affirmative, the merchandise is delivered to the designated location. Referring to FIG. 2. The delivery management center 250 is such as equipped with a merchandise repository 252 for temporarily storing the merchandise purchased by the shopper, and providing home delivery service to the shopper. In an embodiment, the system administrator can set a delivery threshold according to the quantity or amount of merchandise, and the merchandise is delivered to the designated location if the delivery threshold is reached. Thus, after the shopper settles the accounts, the shopper can leave without carrying the purchased merchandise in person or even can go for other leisure activities and leave the purchased merchandise to be delivered by the delivery management center 250. If the shopper has a car and does not need the delivery service, the shopper can go to the delivery management center 250 to pick and check the purchased merchandise, load the merchandise to the car and then drive home.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A purchasing-assistance device, comprising:
a portable body carried by a shopper and used for recording an information of a merchandise purchased by the shopper, calculating the quantity and amount of the merchandise, and temporarily storing a result of calculation and listing the information on a purchase list, wherein the portable body comprises:
a merchandise identification unit used for reading a code of the merchandise to confirm a type and price of the merchandise;
a data input unit used for confirming and calculating the purchased quantity and amount of the merchandise;
a merchandise information display unit used for displaying the type, quantity and amount of each merchandise in the purchase list; and
a data transmission unit used for transmitting the purchase list to a trade center for the shopper to settle accounts with; and
a sensing detecting module disposed on the portable body to determine whether the portable body is positioned within a use range before the accounts are settled, and the portable body is withdrawn and the sensing detecting module is disabled after the accounts are settled.

2. The device according to claim 1, wherein the portable body further comprises a member card reading module used for reading the shopper's profile information to confirm the shopper's identity.

3. The device according to claim 1, further comprising a sensing detecting module disposed on the portable body to determine whether the portable body is positioned within a use range.

4. The device according to claim 1, wherein the merchandise identification unit comprises an optical pick-up head used for reading the code of the merchandise.

5. The device according to claim 1, wherein the merchandise identification unit comprises an image identifier used for identifying the code of the merchandise.

6. A purchasing-assistance system, comprising:
at least a portable body providing for a shopper to carry with and used for recording an information of a merchandise purchased by the shopper, calculating the quantity and amount of the merchandise, and temporarily storing a result of calculation and for listing the information on a purchase list for the shopper to settle accounts with;
a merchandise display center used for providing a code of the merchandise to be read for the shopper to confirm a type and price of the merchandise;
a data exchange center used for transmitting data with each portable body for recording the type, purchased quantity and amount of each merchandise in each purchase list;
a sensing detecting module disposed on the portable body to determine whether the portable body is positioned within a use range before the accounts are settled; and
a trade center connected to the data exchange center for settling accounts with the shopper and withdrawing the portable body and disabling the sensing detecting module after the accounts are settled.

7. The system according to claim 6, further comprising:
a delivery management center used for delivering the merchandise to a location registered or designated by the shopper according to the content of the shopper's purchase list.

8. The system according to claim 6, further comprising:
a delivery management center used for determining whether the total quantity of the merchandise purchased by the shopper or the total amount of consumption of the shopper reaches a delivery threshold: if yes, the merchandise is delivered to a designated location.

9. The system according to claim 6, wherein each portable body comprises:
a merchandise identification unit used for reading a code of each merchandise to confirm the type and price of each merchandise;
a data input unit used for confirming and calculating the purchased quantity and amount of each merchandise;
a merchandise information display unit used for displaying the type, quantity and amount of each merchandise in the purchase list; and
a data transmission unit used for transmitting the purchase list to the trade center for the shopper to settle accounts with.

10. The system according to claim 6, wherein the portable body further comprises a member card reading module used for reading the shopper's profile information to confirm the shopper's identity.

11. The system according to claim 9, wherein the portable body further comprises a member card reading module used for reading the shopper's profile information to confirm the shopper's identity.

12. The system according to claim 6, further comprising a sensing detecting module disposed on the portable body to determine whether the portable body is positioned within a use range.

13. The system according to claim 9, further comprising a sensing detecting module disposed on the portable body to determine whether the portable body is positioned within a use range.

14. A personal purchasing assistance method, comprising:
providing a portable body for a shopper to carry with;
reading a code of a merchandise by the portable body to confirm a type and price of the merchandise;
calculating the quantity and amount of the merchandise, and temporarily storing a result of calculation;
recording an information of the merchandise purchased by the shopper in the portable body and listing the information on a purchase list;
transmitting the purchase list to a trade center;
determining whether the portable body is positioned within a use range before the accounts are settled; and
settling the accounts by the trade center according to the purchase list and withdrawing the portable body and disabling the sensing detecting module after the accounts are settled.

15. The method according to claim 14, further comprising:
delivering the merchandise to a location registered or designated by the shopper according to the content of the shopper's purchase list.

16. The method according to claim 14, further comprising:
determining whether a total quantity of the merchandise purchased by the shopper or a total amount of consumption of the shopper reaches a delivery threshold: if yes, the merchandise is delivered to a designated location.
